(19) United States
(12) Patent Application Publication
(10) Pub. No.: US 2009/0126568 A1
(43) Pub. Date: May 21, 2009

(54) METHOD FOR REMOVING INTRA-MICROCHANNEL BUBBLES AND INTRA-MICROCHANNEL DISSOLVING AND DISPERSING METHOD

(76) Inventors: Hideyuki Karaki, Minami-Ashigara-shi (JP); Goro Takada, Minami-Ashigara-shi (JP); Akira Wakabayashi, Minami-Ashigara-shi (JP)

Correspondence Address: BIRCH STEWART KOLASCH & BIRCH, PO BOX 747, FALLS CHURCH, VA, 22040-0747, US

(21) Appl. No.: 12/271,784

(22) Filed: Nov. 14, 2008

(30) Foreign Application Priority Data
Nov. 15, 2007 (JP) P2007-296999

(51) Int. Cl. B01D 19/00

(52) U.S. Cl. 95/245

(57) ABSTRACT

A method for removing intra-microchannel bubbles, which removes bubbles occurring in a microchannel, is provided; the method including: allowing a liquid that contains bubbles and is introduced into a microchannel to flow in a first direction at a first flow speed at which the bubbles float upward and can remain adhered on an inner wall of the microchannel or less; and then allowing the liquid to flow in a second direction that is opposite to the first direction to move a gas-liquid interface of the liquid, which is a rear end of the liquid in the second direction, in the second direction at a second flow speed at which the bubbles adhered on the inner wall of the microchannel can maintain an adhesion position so as to collect the bubbles on the gas-liquid interface and make the bubbles disappear by exposing the bubbles to a gas.

### BACKGROUND OF THE INVENTION

1. Field of the Invention

This invention relates to a method for removing intra-microchannel bubbles which removes bubbles occurring in a microchannel and an intra-microchannel dissolving and dispersing method which uses the method for removing bubbles to dissolve a porous substance.

2. Description of the Related Art

In recent years, a method using a microchannel chip as a system for realizing analysis and chemical reaction treatment of a trace amount of sample inexpensively and rapidly has been proposed.

The microchannel chip is applied to an inspection apparatus for supplying a liquid to the microchannel chip and executing an inspection. As the inspection apparatus, for example, a biochemical treatment apparatus disclosed in Japanese Patent Laid-Open No. 2006-170654, etc., is available. It includes a stage for placing a biochemical reaction cartridge (microchannel chip) having chambers and a channel for allowing the chambers to communicate with each other, move means for moving a liquid through the channel, detection means for detecting the presence or absence of a liquid in the chamber or the liquid amount, and determination means for determining the move result of the liquid according to information of the liquid in the chamber, wherein a sample preliminarily treated in the microchannel is guided into the chamber and the sample is analyzed from a chemical reaction or a biochemical reaction between an inspection reagent and the sample in the chamber.

In the microchannel, the inspection reagent is carried in the chamber and a solution containing the sample is introduced thereinto. At this time, preliminary treatment of mixing a reaction acceleration substance (reagent) in the sample or mixing a predetermined reaction substance in the sample to isolate or dissolve and amplify a specific component in the sample or the like is also conducted so that the inspection reagent and the sample react with each other efficiently.

Proposed as an intra-microchannel mixing method of mixing a substance and a sample used for such preliminary treatment and reaction treatment for analysis is a method of previously carrying a substance used for preliminary treatment and reaction treatment for analysis in a dry state in a part of the inner wall face of a microchannel, allowing a sample to flow into the microchannel, and dissolving and mixing the substance for preliminary treatment and reaction treatment for analysis in the sample as the substance and the sample carried in the microchannel come in contact with each other. (For example, refer to Japanese Patent Laid-Open No. 2004-194652 and Japanese Patent Laid-Open No. 2006-133003.)

### SUMMARY OF THE INVENTION

As a drying method to previously carry a reagent in a dry state in a channel of a microchannel chip, freeze drying is effective particularly to make it possible to preserve a substance, which is easy to deteriorate or be deactivated such as an enzyme, for a long period of time after drying. However, since the freeze-dried reagent in the channel has a porous structure, if an inspected liquid, etc., is introduced and the freeze-dried reagent is dissolved therein, a large number of minute air bubbles occur and, for example, to optically inspect the reagent in the final step, the presence of the air bubbles becomes a large obstacle and an accurate inspection cannot be conducted; this is a problem.

Then, as a method of suppressing occurrence of air bubbles when a freeze-dried substance is dissolved, Japanese Patent Laid-Open No. H06-54897 and WO 2003/061683 disclose a method of dissolving a freeze-dried substance in a reduced pressure state. However, if this method is applied to a freeze-dried substance carried in a channel of a microchannel chip, the apparatus becomes complicated; this is a problem.

In the channel of the microchannel chip, unexpected air bubbles may occur in the process of mixing, etc., at each point and there is a demand for eliminating the bubbles in the channel.

Therefore, an object of the invention relates to solving above problems and is to provide a method for removing intra-microchannel bubbles which is capable of removing bubbles in a channel of a microchannel chip and an intra-microchannel dissolving and dispersing method which uses the method for removing bubbles and is capable of making the bubbles disappear even when a freeze-dried reagent is dissolved and mixed in an inspected liquid, etc.

The above-mentioned object of the invention can be accomplished by the following configurations.

(1) A method for removing intra-microchannel bubbles, which removes bubbles occurring in a microchannel, the method comprising:

allowing a liquid that contains bubbles and is introduced into a microchannel to flow in a first direction at a first flow speed at which the bubbles float upward and can remain adhered on an inner wall of the microchannel or less; and then allowing the liquid to flow in a second direction that is opposite to the first direction to move a gas-liquid interface of the liquid, which is a rear end of the liquid in the second direction, in the second direction at a second flow speed at which the bubbles adhered on the inner wall of the microchannel can maintain an adhesion position so as to collect the bubbles on the gas-liquid interface and make the bubbles disappear by exposing the bubbles to a gas.

According to the configuration, the bubbles in the liquid introduced into the microchannel is floated upward and is adhered on the inner wall of the channel and the gas-liquid interface of the liquid containing the bubbles is moved at the flow speed at which the bubbles can maintain the adhesion position on the inner wall of the channel, whereby the bubbles are draggled to the moving gas-liquid interface at the rear end in the liquid traveling direction and is accumulated thereto. The bubbles thus accumulated are exposed to the gas side on the gas-liquid interface and gradually disappear. Therefore, a good liquid containing no air bubbles can be allowed to flow into the microchannel.

(2) The method as described in (1) above,

wherein the liquid has two gas-liquid interfaces, and

the two gas-liquid interfaces each moves in a range larger than a range where the bubbles occur.

In doing this configuration, as the rear end between the two gas-liquid interfaces in the liquid traveling direction moves, the bubbles are draggled to the gas-liquid interface at the rear end in the liquid traveling direction, are accumulated and disappear. The move range of the gas-liquid interface is set larger than at least the occurrence range of the bubbles, so that all bubbles in the liquid can be accumulated and be made to disappear and a good liquid containing no air bubbles can be obtained in the microchannel.

(3) An intra-microchannel dissolving and dispersing method for dissolving a porous substance in a microchannel, the method comprising:

introducing a solution into the microchannel where the porous substance is carried therein in a first direction at a third flow speed that is higher than a penetrating speed with capillary effect of the porous substance and dissolving the porous substance in the solution;

allowing the solution to flow in a first direction at a first flow speed at which bubbles occurring in the solution float upward and can remain adhered on an inner wall of the microchannel or less; and then

allowing the solution to flow in a second direction that is opposite to the first direction to move a gas-liquid interface of the solution, which is a rear end of the solution in the second direction, in a second direction at a second flow speed at which the bubbles adhered on the inner wall of the microchannel can maintain an adhesion position so as to collect the bubbles on the gas-liquid interface and make the bubbles disappear by exposing the bubbles to a gas.

In doing this configuration, a solution is introduced into the microchannel at a flow speed higher than the penetrating speed with the capillary effect of the porous substance and the porous substances are dissolved, so that occurring air bubbles are suppressed to a small size. The flow speed of the solution is suppressed so that the bubbles in the solution are floated upward and are adhered on the inner wall of the channel. Next, the gas-liquid interface of the solution in the microchannel is moved at the flow speed at which the bubbles adhered on the inner wall of the channel can maintain the position, and the bubbles are collected on the gas-liquid interface at the rear end in the liquid traveling direction and are made to disappear.

Therefore, the bubbles occurring when a freeze-dried substance is dissolved can be suppressed without providing any special device. It is also made possible to deal with occurrence of unexpected air bubbles in the channel of the microchannel chip.

(4) The method as described in (3) above,

wherein the third flow speed is about 3000 mm/s or more.

(5) The method as described in (3) or (4) above,

wherein the second flow speed is about 50 to 200 mm/s.

### BRIEF DESCRIPTION OF THE DRAWINGS

FIG. 1 is a plan view to show a part of a channel of a microchannel chip according to an aspect of the invention;

FIG. 2A is a partially enlarged view of viewing the gas-liquid interface portion of the channel in FIG. 1 from above in the gravity direction and FIG. 2B is a sectional view of a center line M in FIG. 2A;

FIG. 3 is an exploded perspective view of a microfluid chip according to an aspect of the invention;

FIGS. 4A and 4B are plan views of the microchannel chip where FIG. 4A is a top view and FIG. 4B is a bottom view; and

FIG. 5 is an enlarged view of a first mixing section and a second mixing section.

### DETAILED DESCRIPTION OF THE INVENTION

A preferred embodiment of a method for removing intra-microchannel bubbles according to an aspect of the invention will be discussed in detail with reference to the accompanying drawings.

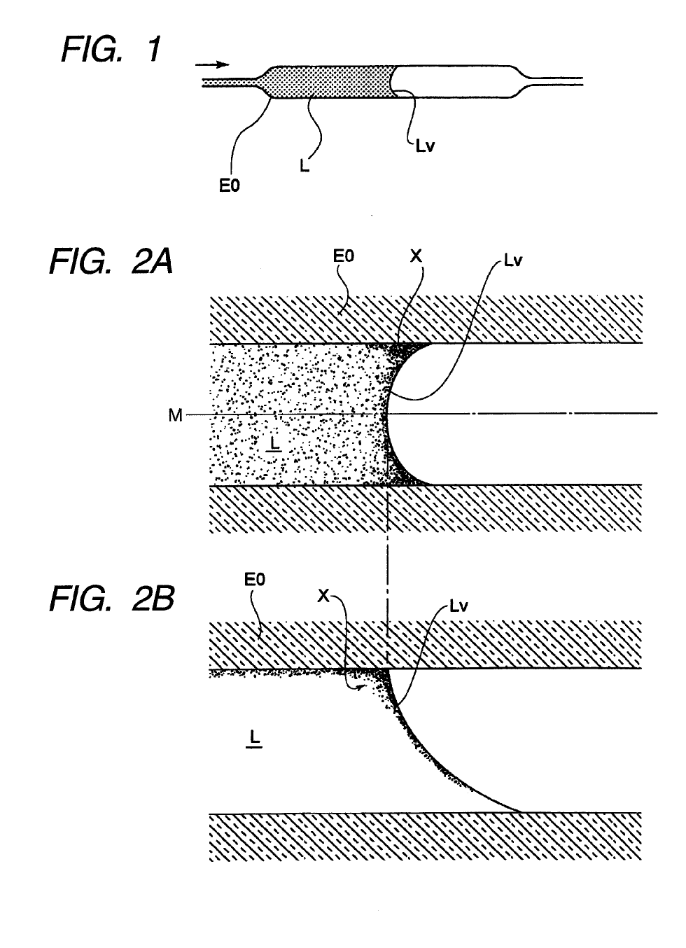

FIG. 1 is a plan view to show a part of a channel of a microchannel chip according to the invention.

A mixing section E0 is a part of a microchannel; in FIG. 1, a liquid L introduced from the left contains a large number of minute air bubbles. When the liquid L is introduced into the mixing section E0, if air bubbles are recognized, the flow speed of the liquid L in the mixing section E0 is set to the speed at which at least the bubbles in the liquid float upward and are adhered on the inner wall of the mixing section E0 or less. As the state in which bubbles float upward, a state in which an internal swirling current does not occur is required and when such a state is entered, the bubbles contained in the liquid L float upward in the gravity direction without stagnation and are adhered on the inner wall of the mixing section E0.

FIG. 2A is a partially enlarged view of viewing a gas-liquid interface portion of the channel in FIG. 1 from above in the gravity direction and FIG. 2B is a sectional view of a center line M in FIG. 2A.

A large number of bubbles X contained in the liquid L and floating upward in the gravity direction in the mixing section E0 as in FIG. 2B are adhered on the inner wall on the liquid L side with a gas-liquid interface Lv as a boundary.

When the bubbles X are thus adhered on the inner wall of the mixing section E0 to some extent, the gas-liquid interface Lv is moved in a liquid level backward movement direction (that is, the liquid L is moved in the opposite direction to the direction in which the liquid L is introduced), then the gas-liquid interface Lv becomes the rear end in the liquid traveling direction. At this time, the liquid flow speed is set to the speed at which the bubbles X can maintain the adhesion position on the inner wall of the mixing section E0 or less. Then, the bubbles X are draggled and are accumulated on the liquid L side of the moving gas-liquid interface Lv. The bubbles thus accumulated are exposed to the gas side on the gas-liquid interface Lv and gradually disappear. Therefore, the gas-liquid interface Lv is moved to a position where the bubbles X are not adhered, whereby the liquid in the microchannel can be made a good liquid containing no air bubbles. If the liquid L in the mixing section E0 is sandwiched between two gas-liquid interfaces Lv, it is also possible to move beyond the range in which the bubbles X are adhered.

The flow speed of the liquid L when the bubbles in the liquid float upward and are adhered on the inner wall of the mixing section E0 and the flow speed of the liquid L when the bubbles are draggled and are accumulated on the liquid L side of the moving gas-liquid interface Lv must be smaller than the introduction speed of the liquid L into the mixing section E0, and are preferably 1000 mm/s or less, more preferably 50 to 200 mm/s and particularly preferably 50 to 100 mm/s.

Next, an intra-microchannel dissolving and dispersing method in an actual microchannel chip with a reagent solidified and carried in a reagent carrying channel will be discussed with reference to the accompanying drawings to show the embodiment.

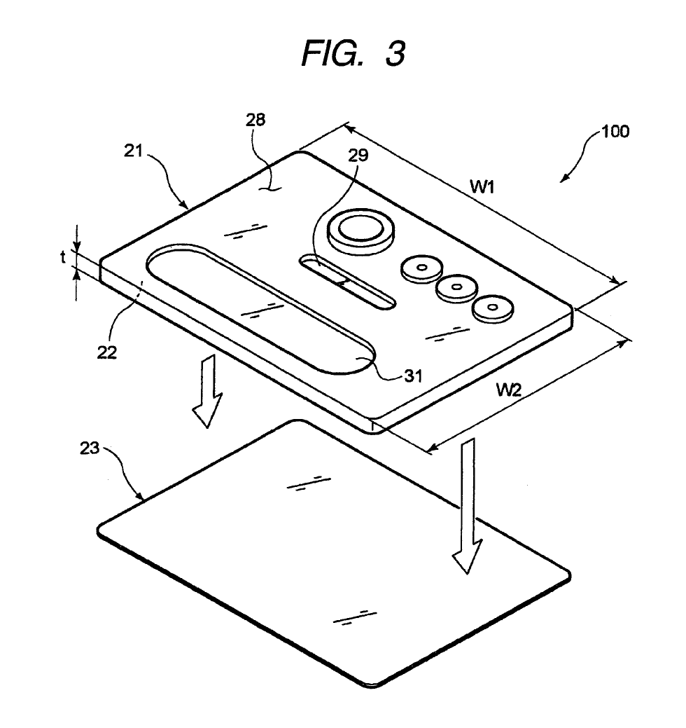

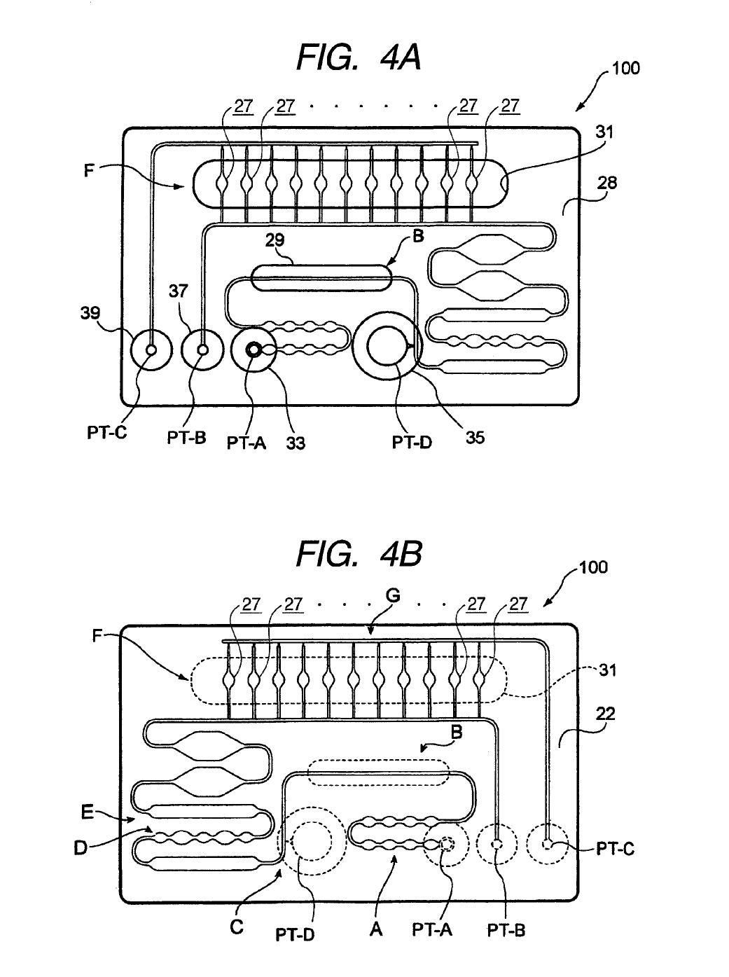

FIG. 3 is an exploded perspective view of the microfluid chip according to the invention. FIGS. 4A and B are plan views of the microchannel chip where FIG. 4A is a top view and FIG. 4B is a bottom view.

A microfluid chip 100 is made up of a channel substrate 21 and a lid 23 put on one face (lower face) 22 of the channel substrate 21, as shown in FIG. 3. The channel substrate 21 is manufactured by injection molding of a thermoplastic high polymer. Although the high polymer to be used is not limited, it is desirable that the high polymer should be optically transparent, have high heat resistance, be chemically stable, and be easily injection molded; COP, COC, PMMA, etc., is preferred. The expression “optically transparent” is used to mean that transmittance is high in the wavelengths of excitation light and fluorescence used for detection, that scattering is small, and autofluorescence is small. Since the chip 100 has light-transmittancy for making it possible to detect fluorescence, for example, SYBR green is used for a detection reagent and it is made possible to measure fluorescence emitted as it is intercalated into double stranded DNA amplified by reaction. Accordingly, it is made possible to detect the presence or absence of a gene sequence as a target.

The microchannel chip 100 is set in an inspection apparatus (not shown) for use and is discarded after once used. In the embodiment, blood (whole blood) of a sample is poured into the microfluid chip 100. The microfluid chip 100 is set in the inspection apparatus, whereby the sample liquid is handled by a physical action force from the outside of the chip and, for example, a plurality of target genes of monobasic polymorphism are inspected; reaction to amplify the nucleic acid of the target sequence isothermally and specifically and detection thereof can be realized on the chip 100 as shown in JP-A-2005-160387. Accordingly, for examples the target nucleic acid is amplified and is detected, whereby it is made possible to amplify and detect the target nucleic acid specific to the pathogen causing an infectious disease, and it is made possible to determine whether or not the pathogen exists in the sample, etc.

In the embodiment, the physical action force is a pneumatic action force (pneumatic drive force) generated by air supply or air suction from port parts PT provided at the start point and the end point of a liquid channel. Therefore, it is made possible to perform move control of liquid supplied to the liquid channel to any desired position in the liquid channel by air supply or air suction acted on the start point and the end point of the liquid channel. At this time, the liquid is held in a state in which it is clamped in the gas intervening between the start point and the tip part of the liquid and between the rear end part of the liquid and the end point and is not broken midway by the action of a tensile force.

The channel substrate 21 is formed on an opposite face (upper face) 28 with excavations 29 and 31, which are positioned corresponding to a heated section B and a reaction section F, respectively. Openings 33, 35, 37, and 39 communicating with a first port PT-A, a second port PT-D, a third port PT-B, and a fourth port PT-C are made in the lower face 22 of the channel substrate 21 as shown in FIG. 2. The channel substrate 21 is formed, for example, as outer dimensions of 55×91 mm of length W2×breadth W1 and having a thickness t of about 2 mm.

The lid 23 is a member for lidding the ports, the cells, and the channels (grooves) formed on the channel face (lower face 22) of the channel substrate 21, and the lid 23 and the channel substrate 21 are joined with an adhesive or a pressure sensitive adhesive. A sheet-like high polymer which is optically transparent, has high heat resistance, and is chemically stable is used as the lid 23 like the channel substrate. In the embodiment, a material provided by applying a silicon-based pressure sensitive adhesive to a plastic film is used. Further, the channel width is 1 mm and some portions as in a part of a mixing section, etc., are made thicker than 1 mm.

The channel substrate 21 is formed with the ports, the cells, the channels, etc., for performing necessary operation on liquid. That is, the channel substrate 21 includes the first port PT-A for inputting sample liquid containing biological cells and a pretreatment reagent (first liquid), the second port PT-D for inputting a reaction amplification reagent (second liquid), the third port PT-B for supplying air pressure to the channel, the fourth port PT-C at the channel termination where pressure is reduced, a first channel (sample mixing section) A for mixing the sample liquid and the pretreatment reagent input from the first port PT-A to generate a first mixed liquid, a second channel (heated section) B for heating the first mixed liquid, extracting DNA from the biological cell, and decomposing the DNA into a single strand, a third channel (reagent merge section) C for allowing the reaction amplification reagent to merge with the first mixed liquid treated in the heated section B, a fourth channel (enzyme retention section) D solidifying and installing an enzyme (first solid) whose dissolution advances with the passage of the second mixed liquid merged in the reagent merge section C, a fifth channel (enzyme mixing section) E for promoting mixing of the enzyme into the second mixed liquid treated in the enzyme retention section D, a plurality of sixth channels (reaction section) F connected to the enzyme mixing section E for executing DNA amplification by dissolving and heating a primer (second solid) solidified and installed in the channel and detection of DNA amplification at the same position, and a seventh channel (fixed-quantity dispensing channel) G connected to the channel of the reaction section F for dispensing a fixed quantity of the second mixed liquid treated in the enzyme mixing section E to each of a plurality of reaction detection cells 27 of the reaction section F.

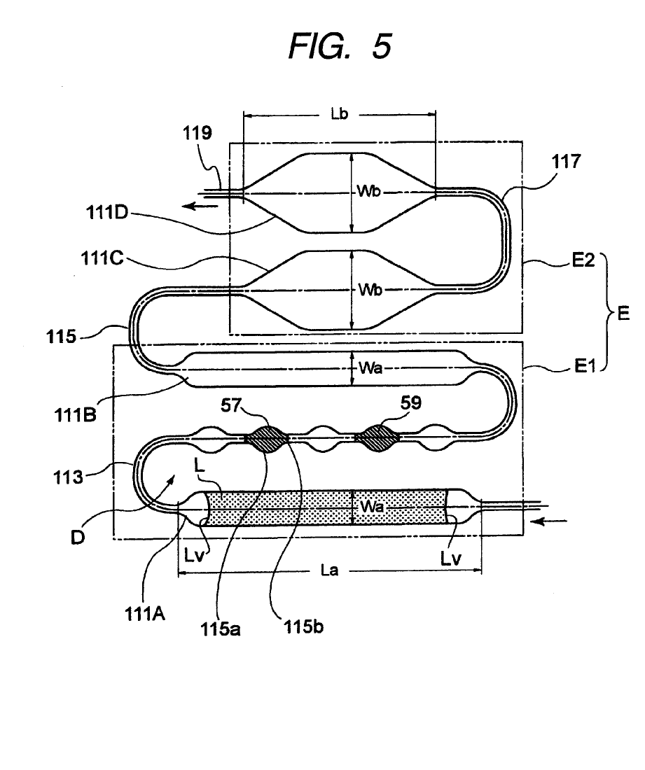

FIG. 5 is an enlarged view of a first mixing section and a second mixing section.

The mixing section E has a first mixing section E1 and a second mixing section E2 placed in order from the second port D, as shown in FIGS. 4A, 4B and 5.

In the first mixing section E1, first channel parts 111A and 111B having a larger vertical cross-sectional area in the flowing direction of liquid than the vertical cross-sectional area in any other channel and second channel parts 113 and 115 having a smaller vertical cross-sectional area than the first channel part 111A, 111B are formed alternately. That is, from the upstream side, the first channel part 111A at the preceding stage, the second channel part 113 at the preceding stage, the first channel part 1118 at the following stage, and the second channel part 115 at the following stage are disposed in order.

In the second mixing section E2, first channel parts 111C and 111D having a larger vertical cross-sectional area in the flowing direction of liquid than the vertical cross-sectional area in any other channel and second channel parts 117 and 119 having a smaller vertical cross-sectional area than the first channel part 111C, 111D are formed alternately. That is, from the upstream side, the first channel part 111C at the preceding stage, the second channel part 117 at the preceding stage, the first channel part 111D at the following stage, and the second channel part 119 at the following stage are disposed in order.

The vertical cross-sectional area of the first channel part 111A, 111B in the first mixing section E1 is formed smaller than the vertical cross-sectional area of the first channel part 111C, 111D in the second mixing section E2. In the embodiment, the depths in the mixing sections (vertical direction depth to the plane of FIG. 4) are made the same and a width Wa of the first channel part 111A, 111B is formed smaller than a width Wb of the first channel part 111C, 111D (Wa<Wb), as show in FIG. 5. A channel direction length La of the first channel part 111A, 111B in the first mixing section E1 is formed longer than a channel direction length Lb of the first channel part 111C, 111D in the second mixing section E2 (La>Lb). In the embodiment, the first channel parts 111A, 111B, 111C, and 111D are formed in parallel and the second channel parts 113, 115, 117, and 119 are formed so as to join the first channel parts, but the placement is not limited to it; any desired placement may be adopted.

The enzyme retention section D is placed in the second channel part 113 between the first channel parts 111A and 111B. Like the mixing section A, the enzyme retention section D is implemented as a channel formed with an alternating pattern of a wide channel part 115A and a narrow channel part 115B along the liquid flowing direction. Some of the wide channel parts 115A become reagent retention cells for retaining a reagent 57 dried and solidified by freezing and drying after a water solution of polymerase and dextrin is put as a drip and a reagent 59 dried and solidified by freezing and drying after a water solution of MutS and dextrin is put as a drip.

The enzyme mixing section E causes the merge liquid of the blood, the pretreatment liquid, and the reaction amplification reagent to go and return between the first channel parts 111A and 111B of the first mixing section E1, thereby dissolving the reagent 57 of a first enzyme and the reagent 59 of a second enzyme and mixing the merge liquid.

The channels upstream and downstream from the wide channel part 115A of the enzyme retention section D retaining the reagent 57, 59 are thinner than the retention section so as to prevent the solidified reagent 57, 59 from peeling off and flowing out to the preceding or following channel due to vibration of retention, transport, etc., of the chip 100 if there is no adhesion of the dried and solidified reagent 57, 59 to the channel.

Next, the intra-microchannel dissolving and dispersing method of the invention in the microchannel chip as described above will be discussed.

The liquid passing through the first channel part 111A in the first mixing section E1 dissolves the reagents 57 and 59 of porous substances at the enzyme retention section D position. A solution is introduced into the microchannel at a flow speed higher than the penetrating speed with the capillary effect of the porous substance, usually at about 3000 μl/min, or about 3000 μl/min or more (flow speed about 3000 mm/s, or flow speed about 3000 mm/s or more) and the porous substances are dissolved, so that occurring air bubbles are suppressed to a small size.

Next, all liquid dissolving the reagents 57 and 59 is introduced to the first channel part 111B. At this time, the possibility that bubbles as shown in FIGS. 1, 2A and 2B may occur in the liquid is high. Then, the flow speed is reduced or the flow is stopped and bubbles in the liquid are floated upward and are adhered on the inner wall of the first channel part 111B. Next, the gas-liquid interface Lv is moved in the liquid level backward movement direction in a state in which the flow speed is reduced to about 50 to 200 μl/min (flow speed 50 to 200 mm/s). The gas-liquid interface Lv is moved back at this flow speed, whereby it is made possible for the bubbles adhered on the inner wall of the first channel part 111B to maintain the position.

Then, the bubbles are draggled and are accumulated on the liquid L side of the moving gas-liquid interface Lv. The bubbles thus accumulated are exposed to the gas side on the gas-liquid interface Lv and gradually disappear. The gas-liquid interface Lv is moved at least from the first channel part 111B to the first channel part 111A, whereby the bubbles can be made completely to disappear.

In fact, after this, the flow is further inverted and the liquid is moved to the second mixing section E2; before this, to completely make the bubbles disappear, the liquid can also be caused to go and return between the first channel parts 111A and 111B.

Thus, preferably the volume of each of the first channel part 111A at the preceding stage and the first channel part 111B at the following stage is set to a volume capable of accommodating the whole one liquid delivered from the second port PT-D, and preferably the volume is 80% or more of the volume of the whole delivered liquid. If the viscosity of the liquid is too high, removal of bubbles and dissolving of the reagents are also hindered and therefore about 1 mPa·s is required.

Therefore, bubbles occurring when a freeze-dried substance is dissolved can be suppressed without providing any special device. It is also made possible to deal with occurrence of unexpected air bubbles in the channel of the microchannel chip.

In the example shown in the figure, the mixing sections E1 and E2 are provided each with two first channel parts, but the number of the first channel parts is not limited to two and a larger number of first channel parts may be formed alternately with the second channel part.

Application of the intra-microchannel mixing method according to the invention is not limited to mixing of the mixed substances in the microchannel chip shown above in the embodiment, and the intra-microchannel mixing method according to the invention can be applied to embodiments other than the exemplified microchannel chip. It can be applied in a similar manner if two or more types of mixed substances are mixed in a microchannel shaped like a capillary.

According to the method for removing intra-microchannel bubbles and the intra-microchannel dissolving and dispersing method according to the invention, the bubbles in the liquid introduced into the microchannel (particularly, the bubbles occurring when a porous substance such as a freeze-dried substance is dissolved in a solution of an inspected liquid, etc.,) can be erased or suppressed without providing any special device. It is also made possible to deal with occurrence of unexpected air bubbles in the channel of the microchannel chip.

The entire disclosure of each and every foreign patent application from which the benefit of foreign priority has been claimed in the present application is incorporated herein by reference, as if fully set forth.

What is claimed is:

1. A method for removing intra-microchannel bubbles, which removes bubbles occurring in a microchannel, the method comprising:
allowing a liquid that contains bubbles and is introduced into a microchannel to flow in a first direction at a first flow speed at which the bubbles float upward and can remain adhered on an inner wall of the microchannel or less; and then
allowing the liquid to flow in a second direction that is opposite to the first direction to move a gas-liquid interface of the liquid, which is a rear end of the liquid in the second direction, in the second direction at a second flow speed at which the bubbles adhered on the inner wall of the microchannel can maintain an adhesion position so as to collect the bubbles on the gas-liquid interface and make the bubbles disappear by exposing the bubbles to a gas.

2. The method according to claim 1,
wherein the liquid has two gas-liquid interfaces, and
the two gas-liquid interfaces each moves in a range larger than a range where the bubbles occur.

3. An intra-microchannel dissolving and dispersing method for dissolving a porous substance in a microchannel, the method comprising:
introducing a solution into the microchannel where the porous substance is carried therein in a first direction at a third flow speed that is higher than a penetrating speed with capillary effect of the porous substance and dissolving the porous substance in the solution;
allowing the solution to flow in a first direction at a first flow speed at which bubbles occurring in the solution float upward and can remain adhered on an inner wall of the microchannel or less; and then
allowing the solution to flow in a second direction that is opposite to the first direction to move a gas-liquid interface of the solution, which is a rear end of the solution in the second direction, in a second direction at a second flow speed at which the bubbles adhered on the inner wall of the microchannel can maintain an adhesion position so as to collect the bubbles on the gas-liquid interface and make the bubbles disappear by exposing the bubbles to a gas.

4. The method according to claim 3,
wherein the third flow speed is about 3000 mm/s or more.

5. The method according to claim 3,
wherein the second flow speed is about 50 to 200 mm/s.
